(19) United States
(12) Patent Application Publication
(10) Pub. No.: US 2009/0107441 A1
(43) Pub. Date: Apr. 30, 2009

(54) Adaptive fuel control strategy for engine starting

(75) Inventors: Philip William Husak, Southgate, MI (US); Daniel Lawrence Meyer, Dearborn, MI (US); Venkateswaran Nallaperumal, Orchard Park, NY (US); Mike Ryan Scannell, New Boston, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 11/925,532

(22) Filed: Oct. 26, 2007

(51) Int. Cl. F02D 41/06

(52) U.S. Cl. 123/179.16; 123/491

(57) ABSTRACT

As one example, a method is provided for controlling a relative amount of air and fuel that is provided to a combustion chamber of an internal combustion engine. The method comprises adjusting a relative amount of air and fuel provided to the combustion chamber during an engine start based on a volatility of the fuel identified during a previous engine start. As another example, a vehicle engine system is provided, comprising: an internal combustion engine including at least one combustion chamber; a fuel injector configured to provide fuel to the combustion chamber; a fuel system operatively coupled with the fuel injector including a fuel storage tank; a control system configured to vary an amount of fuel injected into the combustion chamber during an engine start based on a speed response of the engine during a previous engine run-up from rest and a change in an amount of fuel stored in the fuel storage tank before the engine start.

### BACKGROUND AND SUMMARY

Fuel volatility can impact engine starting performance of an engine. For example, fuel volatility can have an impact on air/fuel ratio during engine start-up, thereby affecting engine combustion. Thus, various approaches may be used for adjusting engine fuel injection during starting to compensate for such volatility effects.

One example of fuel injection control is described in U.S. Pat. No. 7,163,002. In this example, engine start-up speed can be used as an indicator for fuel volatility. Specifically, the discrepancy between the actual or measured engine speed and a modeled engine speed may be used to indicate fuel volatility, and the amount of fuel injected during the start adjusted in response thereto. Further, the fuel volatility indication is also used to adjust transient fuel injection to account for the effects of fuel volatility on fuel adhered to the intake manifold, intake valves, and/or intake ports.

The inventors herein have recognized some issues with the above approach. As one example, the indication of fuel volatility that may be identified from the discrepancy in engine speed is relearned during each subsequent engine start, based on the particular engine speed profile for that particular start. This approach can lead to an initial decrease or “sag” in the engine speed during start-up that may occur before the volatility or fuel quality is identified. In other words, a speed discrepancy first occurs during any given engine start before compensation is generated. Even this reduced decrease in engine speed (as compared to an engine stall, for example) can lead to increased emission during start up and customer dissatisfaction.

In one example, at least some of the above issues may be addressed by a method for controlling an amount of air or fuel provided to a combustion chamber of an internal combustion engine, the method comprising adjusting an amount of air and fuel provided to the combustion chamber during an engine start based on a volatility of the fuel identified during a previous engine start.

As another example, at least some of the above issues may be addressed by a vehicle engine system, comprising: an internal combustion engine including at least one combustion chamber; a fuel injector configured to provide fuel to the combustion chamber; a fuel system operatively coupled with the fuel injector including a fuel storage tank; a control system configured to vary an amount of fuel injected into the combustion chamber during an engine start based on a speed response of the engine during a previous engine run-up from rest and a change in an amount of fuel stored in the fuel storage tank before the engine start.

In this way, a fuel volatility indicator such as engine speed response during a previous engine start may be used to adjust fuel injection amount during a subsequent engine start-up. For example, the inventors herein have recognized that fuel volatility and/or quality may not significantly change, under some conditions, unless new fuel is provided to the fuel storage tank. By using this previously obtained fuel volatility indicator, the engine is less likely to experience an unexpected change in engine speed due to the affects of volatility or quality of the fuel on air-fuel control during engine start-up. Additionally, as will be described herein, the fuel injection can be further varied during start-up responsive to the addition of new fuel into the fuel storage tank and an estimated time after start-up of the engine when the new fuel can reach the engine.

### BRIEF DESCRIPTION OF THE DRAWINGS

FIG. 1A shows a schematic depiction of an example engine system.

FIGS. 1B-1F show graphs of example fuel delivery strategies during engine start-up.

FIG. 2 is a flow chart depicting an example engine control strategy.

FIG. 3 shows a control diagram.

FIGS. 4-6 are flow charts depicting example engine control strategies.

FIG. 7 shows a flow chart depicting an example control strategy that may be used to apply the ACES and/or HFD algorithms described herein

### DETAILED DESCRIPTION

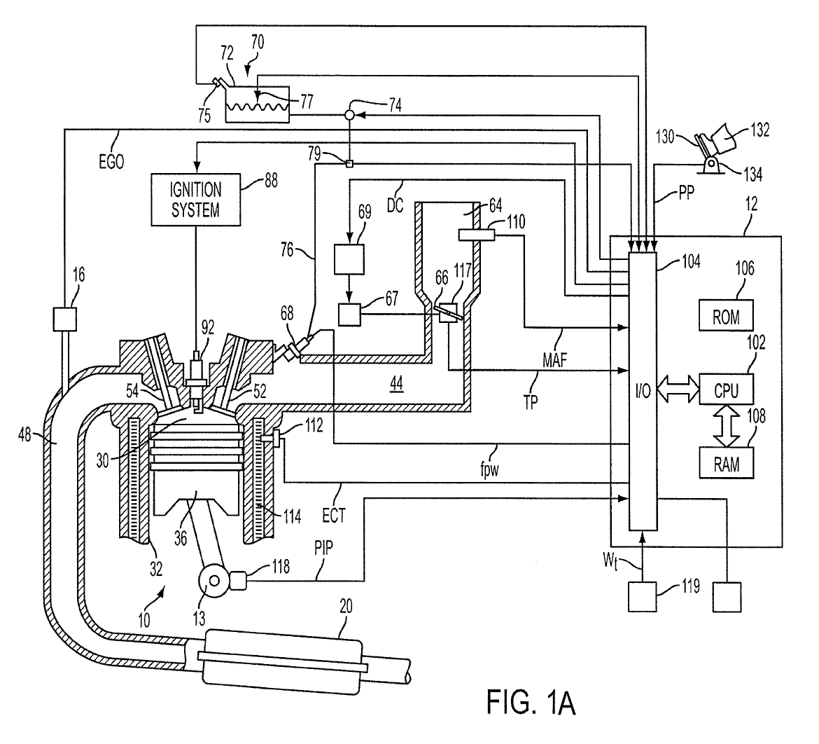

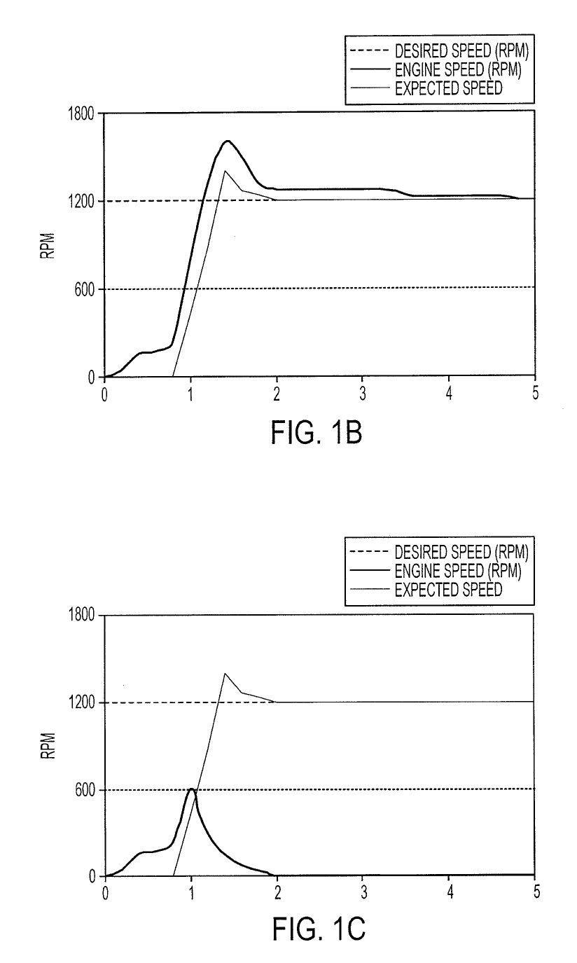

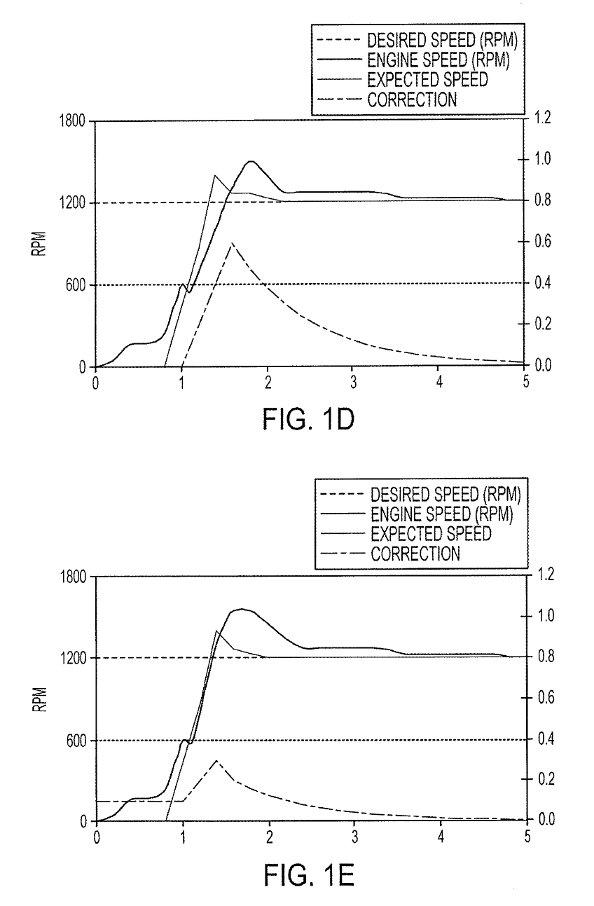

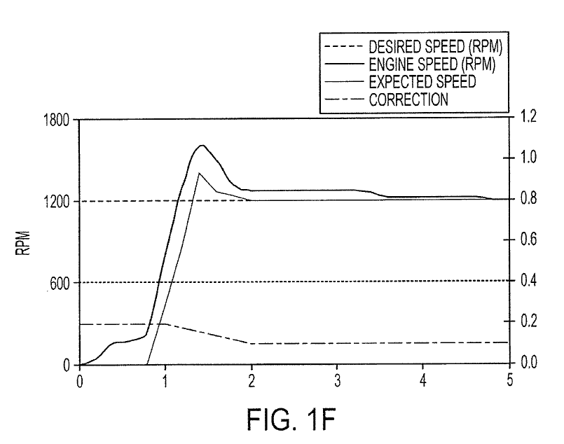

Internal combustion engine 10 comprising a plurality of cylinders, one cylinder of which is shown in FIG. 1, is controlled by electronic engine controller 12. Engine 10 includes combustion chamber 30 defined by combustion chamber walls 32 with a piston 36 positioned therein and connected to crankshaft 13. Combustion chamber 30 can communicate with intake manifold 44 and exhaust manifold 48 via respective intake valve 52 and exhaust valve 54. Exhaust gas oxygen sensor 16 is coupled to exhaust manifold 48 of engine 10 upstream of catalytic converter 20.

Intake manifold 44 communicates with throttle body 64 via throttle plate 66. Throttle plate 66 is controlled by electric motor 67, which receives a signal from ETC driver 69. ETC driver 69 receives control signal (DC) from controller 12.

Intake manifold 44 is also shown including fuel injector 68 coupled thereto for delivering fuel in proportion to the pulse width of signal (fpw) from controller 12. While fuel injector 68 has been provided along an intake passage of engine 10 in a configuration that may be referred to as port injection, in other examples, fuel injector 68 may be configured as an in-cylinder injector for injecting fuel directly into combustion chamber 30 in a configuration that may be referred to as direct injection.

Fuel can be delivered to fuel injector 68 by a fuel system 70 including a fuel storage tank 72, fuel pump 74, and fuel rail 76. Fuel pump 74 can receive fuel pump control signals from controller 12 to enable the controller to control the pressure at which the fuel is provided to fuel injector 68 via fuel rail 76. Fuel system 70 can include various sensors communicating with controller 12. For example, a fuel pressure sensor can be included downstream of fuel pump 74 for providing an indication of the fuel pressure that is provided to fuel injector 68. Controller 12 can vary the duty cycle of pump 74 responsive to feedback from fuel pressure sensor 79 to maintain a target fuel pressure in fuel rail 76. A fuel storage tank sensor 77 may be included to enable controller 12 to identify the amount of fuel stored within the fuel storage tank. As one example, sensor 77 can include a fuel level sensor; however, it should be appreciated that any suitable sensor for identifying the amount of fuel in storage tank 72 may be used. Controller 12 can utilize sensor 77 to determine whether the amount of fuel stored on-board the vehicle has changed, for example, responsive to a refueling operation as well as the magnitude of the change in fuel stored on-board the vehicle. In some examples, a fuel storage tank refueling sensor 75 may be included to provide an indication to controller 12 when a refueling operation has commenced.

Engine 10 further includes a distributorless ignition system 88 to provide ignition spark to combustion chamber 30 via spark plug 92 in response to controller 12. In the example described herein, controller 12 is a microcomputer including: microprocessor unit CPU 102, input/output ports 104, electronic memory chip 106, which is an electronically programmable memory in this particular example, random access memory RAM 108, and a data bus. The RAM may include a keep alive memory storage device in some examples.

Controller 12 receives various signals from sensors coupled to engine 10, in addition to those signals previously discussed, including: measurements of inducted mass air flow (MAF) from mass air flow sensor 110 coupled to throttle body 64; engine coolant temperature (ECT) from temperature sensor 112 coupled to cooling jacket 114; a measurement of throttle position (TP) from throttle position sensor 117 coupled to throttle plate 66; a measurement of turbine speed (Wt) from turbine speed sensor 119, where turbine speed measures the speed of a shaft (not shown), and a profile ignition pickup signal (PIP) from Hall effect sensor 118 coupled to crankshaft 13 indicating an engine speed (N). Alternatively, turbine speed may be determined from vehicle speed and gear ratio.

Continuing with FIG. 1, a user input device may be included such as accelerator pedal 130 for controlling the operation of engine 10. Input from a user or vehicle operator 132 may be identified by pedal position sensor 134 and sent to controller 12 as indicated by a pedal position output signal (PP). In an alternative example, where an electronically controlled throttle is not used, an air bypass valve (not shown) can be installed to allow a controlled amount of air to bypass throttle plate 66. In this alternative example, the air bypass valve (not shown) receives a control signal (not shown) from controller 12.

As will be appreciated by one of ordinary skill in the art in light of the present disclosure, the specific routines described below in the flowcharts may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the disclosure, but is provided for ease of illustration and description. Although not explicitly illustrated, one of ordinary skill in the art will recognize that one or more of the illustrated steps or functions may be repeatedly performed depending on the particular strategy being used. Further, these flowcharts and routines can graphically represent code to be programmed into the computer readable storage medium in controller 12.

During some conditions, fuel delivery control during engine start-up may be scheduled as an open-loop event due to the absence of a robust feedback sensor signal. A particular concern for an engine or vehicle manufacturer is the maintenance of a consistent open-loop fueling control from start-to-start for both an individual engine and across the population of engine, since engine start-up variability can affect both exhaust gas emissions and customer satisfaction. As one approach, some manufacturers typically develop engine start-up calibrations using a representative “mean” or “bogey” test fuel. However, actual or “in-use” fuel selection can vary significantly and can impact start-to-start variability. These “in-use” fuels can have different distillation blending properties, fuel volatilities, and fuel qualities when compared to the “mean” or “bogey” calibration fuel used by the manufacturer for initializing open-loop control. Therefore, for a fixed, open-loop fuel injection pulse-width during start-up, the amount of vaporized fuel that is available for induction into the engine cylinder during start-up may be either greater or less than the calibrated, ideal amount set by the manufacturer. If the amount of vaporized fuel is less than that for the “mean” or “bogey” fuel, inconsistent start-up times may result as a consequence of engine speed variability. In extreme cases, objectionable engine speed “sags” or “dips” or even engine stalls may occur during start-up.

FIG. 1B illustrates an example of a typical or desirable engine start-up event, while FIG. 1C illustrates an example of an engine stall during start-up. For example, as shown in FIG. 1B, the engine speed is at least the expected engine speed during start-up, whereby the engine speed subsequently converges to the desired engine speed. In contrast, the engine start shown in FIG. 1C illustrates how the engine speed can be less than the expected engine speed, for example, in the case where engine stall occurs.

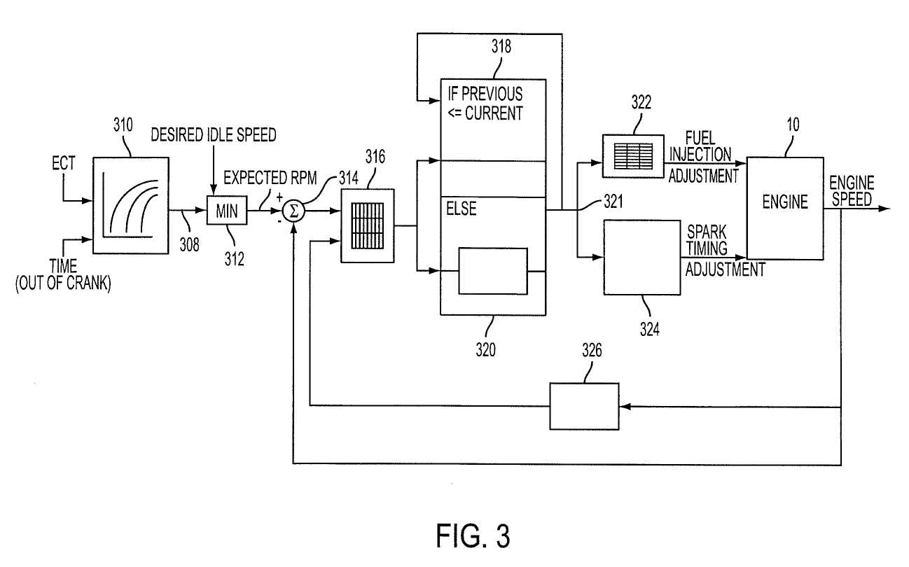

As one approach to address the above issues, an engine control strategy can utilize a Hesitation Fuel Detection (HFD) algorithm (e.g. as described with reference to FIG. 3) in order to mitigate engine speed sags, dips or stalls during start-up that may be caused by lower-volatility or quality fuels or in-use gasoline fuels having a higher Drivability Index (DI). Additionally, an approach referred to herein as: “Adaptive Control for Engine Starting” (ACES) may be applied by the engine control system that utilizes feedback from the HFD algorithm in order to make adaptive corrections to the nominal start-up fuel pulse-width calibration set point commands in order to reduce or minimize activation of the hesitation detection logic, and reduce start-up variability for subsequent engine starting events. For example, if the HFD algorithm is invoked during start-up, an open-loop fuel system error may be calculated based on the magnitude of the hesitation detection multiplier. This error can be stored by the ACES algorithm for use in the open-loop fueling equation during subsequent start-ups.

This algorithm can compare engine speed against a calibratible, prescribed engine speed profile for start-up and idle. If the current engine speed is below the prescribed engine speed, the HFD algorithm may be invoked and the quantity of open-loop fuel delivered to the engine cylinders may be increased until the engine speed either matches or exceeds the desired value for engine speed, as shown in FIG. 1D. Thus, the HFD algorithm has been utilized during engine speed run-up phase, as shown in FIG. 1D, by utilizing a fuel correction to reduce the engine speed reduction that occurred at the time after engine start indicated along the horizontal axis at approximately 1, whereby the engine speed can subsequently converge to the expected engine speed.

However, the above described approach is that the HFD algorithm may be limited where it is reset for each engine start-up. To overcome this limitation and to further reduce start-up variability, an algorithm, “Adaptive Control for Engine Starting” (ACES), is provided that can adaptively correct the open-loop fuel delivery on subsequent start-ups as shown in FIGS. 1E and 1F. For example, FIG. 1E shows how the HFD algorithm may be invoked (e.g. at time 1 indicated along the horizontal axis) in order to correct engine speed “sag” on start-up caused by a higher DI gasoline fuel, and the ACES algorithm is concurrently invoked to learn an open-loop fuel correction term that may be applied and adaptively corrected on subsequent engine start-ups.

FIG. 1F illustrates a mature, high DI gasoline fuel start-up with adaptive learning, whereby the HFD algorithm is not activated because the application of the adapted open-loop fueling correction term as obtained by the ACES algorithm has eliminated or reduced the engine speed sag for this start-up. A comparison of a previous engine start shown in FIG. 1E and a subsequent engine start shown in FIG. 1F demonstrates how the initial fuel correction amount has been increased to eliminate the speed reduction that has occurred during the previous engine start.

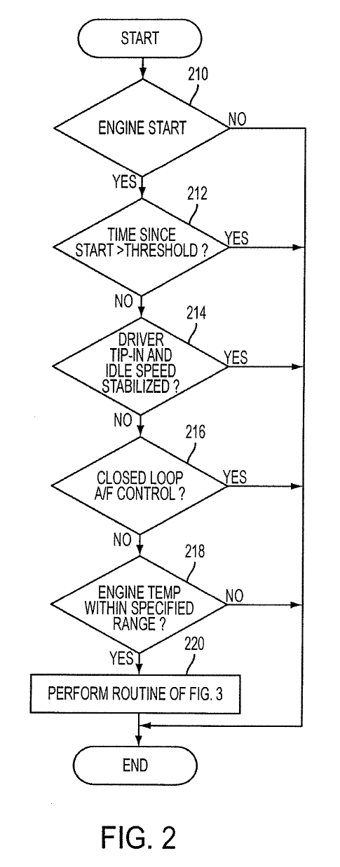

Referring now to FIG. 2, a routine is provided for selecting whether to utilize the ACES and/or HFD algorithms. At 210, it may be judged whether an engine start is being performed. As one example, controller 12 can determine that an engine start is being performed upon an engagement of an engine starter motor, by monitoring whether engine speed is greater than a minimum threshold engine speed, detecting the position of a driver's key position (e.g. on vs. off), or by other suitable approach. When the answer at 210 is yes, the routine can proceed to 212. Alternatively, the routine may end or return to the start of the routine when it is judged that an engine start is not being performed.

At 212, if the time since the engine start has been initiated is greater than a prescribed threshold value, then the routine may return or end. For example, the time since the engine start was initiated may be identified by the engine controller based on a variety of parameters, including: the amount of time after the engine has reached a minimum threshold speed such as 250 rpm or other suitable speed, a number of combustion cycles that have commenced since initiation of the engine start, a number of engine revolutions that have occurred after an initial rotation of the engine by the starter motor, or by other suitable time indication. Alternatively, then the answer at 212 is no (e.g. the time since engine start is less than the minimum time threshold after engine start-up has been initiated), the routine can proceed to 214. In this way, the controller can identify whether the engine is still operating within a start-up phase after initiation of the engine start.

At 214, it may be judged whether a driver tip-in has occurred and/or whether the engine idle speed has stabilized. As one example, a driver tip-in can be determined by the control system based on an assessment of the accelerator pedal position. For example, where the pedal position is greater than a threshold value or has increased by a threshold amount indicative of an increased torque request, the control system may determine that a driver tip-in has occurred. Further, a stable engine idle speed condition may be determined by comparing the measured engine idle speed (e.g. via sensor 118) to the desired or prescribed engine idle speed for the given operating conditions as well as by examining whether the measured engine idle speed has remained within a prescribed proximity to the prescribed engine idle speed for a given period of time or number of engine cycles. If the answer at 214 is no, the routine can continue to 216. Alternatively, the routine may end or return to the start of the routine when it is judged that driver tip-in has occurred or that the engine idle speed has stabilized.

At 216 it may be judged whether close loop air/fuel ratio control is to be enabled. As one example, the controller may determine whether the exhaust gas oxygen sensor has reached a desired operating temperature, in which case fuel injection can be adjusted by the controller based on feedback from the exhaust gas oxygen sensor. If the answer at 216 is no, the routine can proceed to 218. Alternatively, the routine may end or return to the start of the routine when it is judged that closed loop air and fuel control is to be performed.

At 218, it may be judged whether the engine temperature, such as the engine coolant temperature (ECT), is within a specified temperature range. For example, the controller may judge whether the engine temperature is below a prescribed temperature threshold that is indicative of an engine start-up phase. If the answer at 218 is yes, the routine can proceed to 220, whereby the ACES algorithm can be applied as described with reference to FIGS. 3-6. Alternatively, the routine may end or return to the start of the routine when it is judged that the engine temperature is not within a specified engine temperature range. For example, when the engine temperature is greater than a prescribed temperature, the controller may judge that the engine is no longer in the start-up phase and the routine may end or return.

Thus, as described by the routine of FIG. 2, the engine controller can assess whether the engine is operating in a start-up phase after initiation of an engine start and can apply one or more of the various algorithms described herein during the start-up phase to reduce engine hesitation and engine emissions during engine starting.

Turning now to the control flow diagram of FIG. 3, an approach for adjusting the fuel injection amount or relative amount of air and fuel (air/fuel ratio) provided to the engine during start-up responsive to an engine speed response. FIG. 3 provides an example of the HFD algorithm described herein. As one example, this approach may be used to identify a fuel parameter indicative of fuel volatility or fuel quality. While fuel parameters such as volatility and quality can be identified by observing the engine speed response during start-up, it should be appreciated that various other approaches may be used including a fuel quality sensor, fuel density, fuel viscosity, or combinations thereof.

Continuing with FIG. 3, the controller can calculate the expected engine speed run-up profile. In this example, the expected speed is determined as a minimum of two parameters at 312. The first parameter 308 is determined at 310 as a function of engine coolant temperature (ECT), which is represented by the average ECT during the engine start and time out of engine cranking. The time out of engine cranking, or time since start can be, for example, a timer starting after engine speed reaches a minimum threshold, such as approximately 250 RPM. The second variable is a desired idle RPM value, which may be determined by an idle speed control routine (not shown).

Next, the expected engine speed is compared with the actual engine speed at the summing junction of 314. The result of this comparison and an approximate derivative of measured engine speed (e.g., the filtered slope of the speed curve) from 326 are fed to 316. An example filter that may be used to approximate the derivative is a simple first order filter. In 316, the input values may be used to calculate a fractional value (from 0 to 1), where 1 is the maximum output and 0 is the minimum output. In one example the ANTISTALLMUL term may be the fractional output in 316. In an alternate example the ANTISTALLMUL can include the output 321 of 318/320. The output of 316 is then fed to 318 and 320 and filtered depending on the direction of the change. If the output is increasing, no filtering is used (318); however, if the output is decreasing, a simple first order low-pass filter may be used (320). The output of 318/320 is a parameter indicative of a fuel volatility or quality, such as the amount of hesitation type fuel present during the start.

This parameter may then be used to adjust engine operation, such as to adjust a fuel injection amount and/or spark timing via 322 and 324, respectively. For example, this parameter indicative of fuel quality may be used to adjust the desired air-fuel ratio (e.g. by adjusting fuel injection amount) and spark timing. In one example, the parameter is used to adjust the desired air-fuel ratio by increasing the richness of the air-fuel ratio from a base fuel injection term LAMBSE as the parameter increases, where various levels of gain may be used depending on operating conditions. The spark timing may be adjusted by blending spark timing between a base timing (for starting with a minimum fuel quality level) and a maximum limit on spark timing after which torque is reduced.

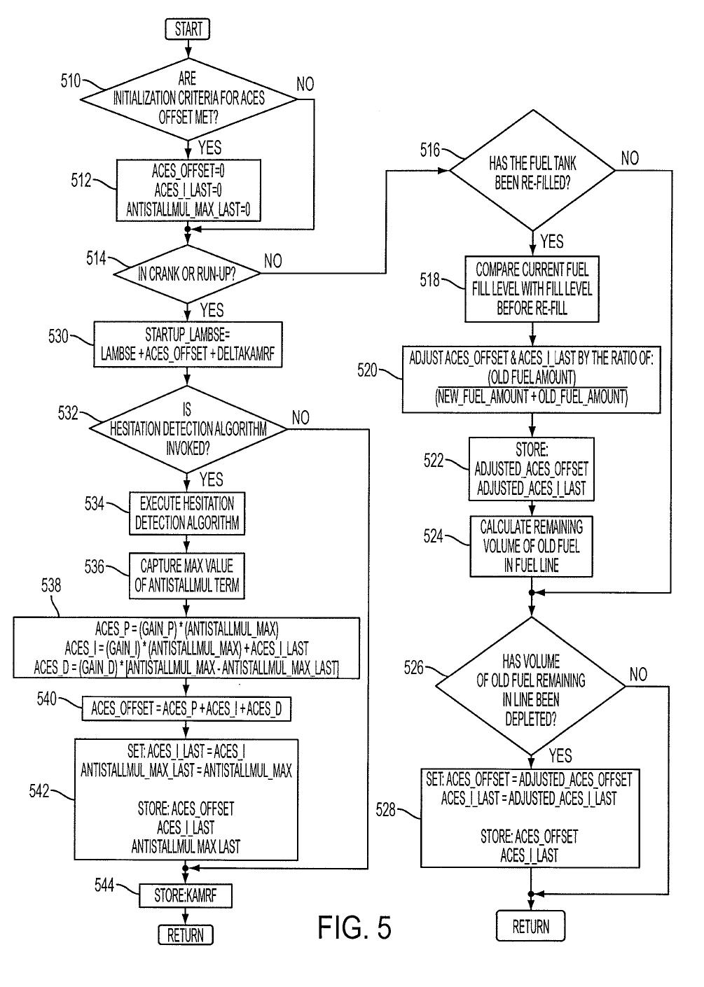

In this way, the potentially lean combustion caused by degraded fuel quality may be compensated by richening the fuel injection and advancing spark timing (from its retarded value during an engine start to provide rapid catalyst heating). As described in greater detail with reference to FIGS. 5-7, the fuel injection during engine start-up can be selected based on the fuel injection adjustment provided (e.g. from 322) during a previous engine starting event.

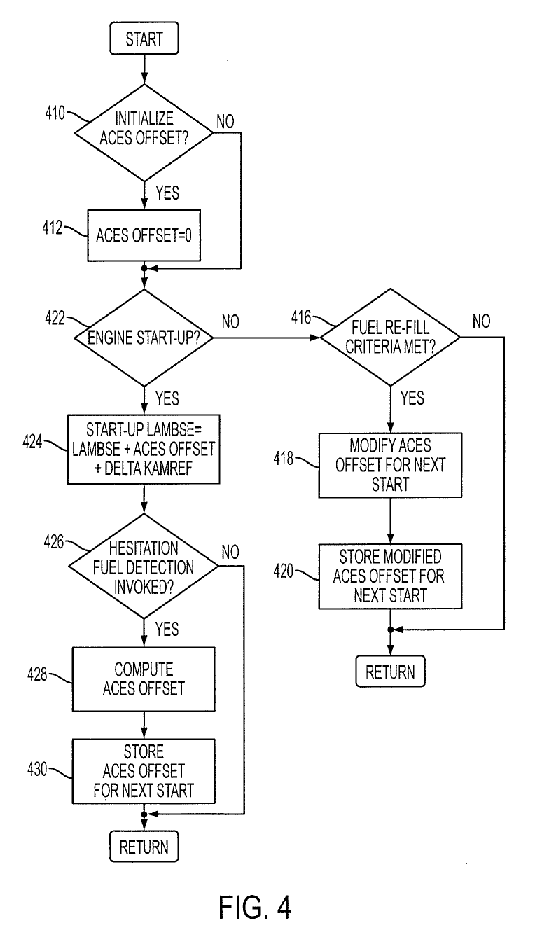

Turning now to FIG. 4, a flow chart is shown which depicts an example of how the ACES algorithm may be applied by the engine controller to reduce variations in engine speed response during start-up, which may otherwise cause dips in engine speed and/or engine stalls. In this particular example, ACES can adaptively correct the open loop fuel delivery on subsequent start-ups based on learned engine speed responses from at least a previous start-up. The ACES algorithm can be much more accurate and reliable than a physics based model, which may require additional input values that may be difficult or costly to accurately measure. As one example, the ACES algorithm can be configured to cause the controller to adjust one or both of the air/fuel ratio provided to the engine and/or spark timing.

Continuing with FIG. 4, at 410, it may be judged if an ACES_OFFSET term (i.e. fuel OFFSET correction term) should be initialized. As one example, initialization of the ACES_OFFSET term stored in memory at the controller may be performed when executing the ACES algorithm for the first time or for specified powertrain diagnostic or failure mode management actions. If the ACES_OFFSET term is to be initialized, then the ACES_OFFSET term stored in memory at the controller can be set to zero at 412. In other words, the fuel OFFSET correction term (e.g. indicative of the change in fuel injection amount during start-up) can be initialized to zero, which can cause the controller to provide a fuel injection amount during start-up that is based on the original manufacturer's settings, for example. However if the ACES_OFFSET term is not to be initialized, then the previous ACES_OFFSET term may be obtained from memory by the controller.

At 422, it may be judged whether engine is currently in the start-up phase. As one example, the controller may utilize the routine of FIG. 2 to identify whether the engine is currently in the start-up phase. For example, the controller may judge that the engine is in the start-up phase based upon whether a command from the controller has been issued to start the engine, whether the time since initiation of the engine start has surpassed a threshold, whether driver tip-in has occurred, whether idle speed has initialized, whether closed loop air/fuel control has been initiated, and/or whether the engine temperature is within a temperature range indicative of start-up. Further, an engine start-up phase may be initiated by engagement of an engine starter motor, monitoring whether engine speed is greater than a minimum engine speed, or when the vehicle operator has moved the key to an engine start position.

If the engine is not within the engine start-up phase, the routine can proceed to 416. At 416, the controller can judge whether fuel re-fill criteria have been met. It can be judged that the fuel re-fuel criteria have been met when the controller detects the addition of fuel to the fuel storage tank or other refueling operation. For example, sensors 77 or 75 may be used by the control system to identify whether a re-fueling operation has occurred. If the refueling criteria have not been met, then the routine can return to the start. However if the refueling criteria has been met, such as where the controller determines that a refueling operation has been performed, then the routine can continue to 418.

At 418, the ACES_OFFSET term may be modified to account for the addition of new fuel to the fuel storage tank. As one example, the controller can identify how much fuel has been added via sensor 77 and can compute the relative increase in the fuel stored in the fuel tank. Based on this relative increase in fuel stored on-board the vehicle, the controller can estimate how the fuel volatility has varied via in response to the refueling operation and can adjust engine operating parameters during start-up accordingly. For example, where the fuel stored on-board the vehicle is degraded or has a lower volatility, the addition of new fuel to the fuel system can reduce the concentration of the degraded fuel and/or increase the overall volatility of the fuel through dilution of the original or old fuel stored on-board the vehicle. Next, the routine can proceed to 420 where the recently calculated or modified ACES_OFFSET value may be stored in the controller where it may be used for the next engine start. From 420, the routine can return to the start of the routine. In this way, the controller can adjust learned values from start to start that are used to select fuel injection amounts based on whether new fuel has been added to the fuel system.

On the other hand if it is judged at 422 that the engine is operating in the start-up phase, the routine can proceed to 424. At 424, an open loop start-up term for the air/fuel ratio indicated as START-UP LAMBSE can be calculated based on the ACES_OFFSET stored in memory. The calculation at 424 may include a summation of a base open-loop startup air/fuel ratio term (LAMBSE), the ACES_OFFSET term stored in memory, and an adjustment term (DELTA KAMRF), which may be stored in keep alive memory at the controller. The ACES_OFFSET term and DELTA_KAMRF term can take on positive or negative values that can be used to adjust the base open-loop air/fuel ratio term (LAMBSE) that may otherwise be used at start-up depending on previous engine speed responses and variations in operating conditions identified by the controller. For example, the DELTA KAMRF term can account for differences between successive engine starts that may be due to air intake and fuel system corrections. As one example, DELTA KAMRF can be computed by subtracting a stored air/fuel ratio KAMRFₖ₋₁, determined by sensors of the engine (e.g. sensor 16), from a current air/fuel ratio KAMRFₖ. The values of KAMRFₖ₋₁ and KAMRFₖ can be stored in the keep alive memory KAM or other suitable memory of the engine controller.

The routine can then proceed to 426 where the controller checks engine conditions and determines if the HFD algorithm has been invoked to correct for engine speed responses that differ from expected engine speed values, such as speed dips or engine stalls. For example, the HFD algorithm may be invoked when the engine speed response includes a decrease in engine speed during start-up, which may result when a fuel of lower volatility or fuel quality is supplied to the engine. If the HFD algorithm is not invoked, then the routine can return. However if the HFD algorithm is invoked to provide engine speed correction, then the routine can proceed to 428 and 430 where the ACES_OFFSET term can be computed and stored, respectively, for the next start. As described with reference to FIG. 3, an updated ACES_OFFSET term can be determined by the controller from feedback provided by the HFD algorithm indicative of the magnitude and vector of the actual engine speed response as it varies from the expected engine speed response.

Referring now to FIG. 5, a flow chart is provided depicting the routine of FIG. 4 in greater detail. Criteria for the initialization of the ACES algorithm can be checked at 510. These criteria for initializing the ACES algorithm may include, but are not limited to: initializing or re-setting the engine controller (e.g. a processor control module (PCM)); executing the ACES algorithm for the first time; certain powertrain diagnostic or failure mode management actions. If the criteria are met for initializing the ACES algorithm, the routine can proceed to 512, where the ACES Offset term (ACES_OFFSET) can be set to zero. Values for the ACES integral term (ACES_I_LAST) and the maximum value of the anti-stall multiplier term (ANTISTALLMUL_MAX) stored in memory at the controller can also be set to zero. Although the various ACES terms have been initialized to zero in this example, these same terms may be initialized to non-zero (e.g. to certain prescribed) values in other applications of this algorithm. The routine can then proceed to 514 whether or not the ACES algorithm terms have been initialized.

At 514, the engine operating state can be checked by the controller. If the engine is not operating in either a crank or the run-up state, the routine can proceed to 516. If the engine is operating in the crank or run-up state, the routine can proceed to 530. At 530, the open-loop fuel lambda term (STARTUP_LAMBSE) used by the controller during engine crank and run-up to select the amount of fuel injection may be computed by adding the base open-loop fuel lambda term (LAMBSE) (e.g. as identified by the manufacturer for a calibration fuel), the ACES_OFFSET term and a Keep-Alive-Memory delta term (DELTAKAMRF). Note that ACES_OFFSET and DELTAKAMRF terms may have either positive or negative values that can cause the controller to vary the air/fuel ratio of the engine during start-up from the base fuel amount for a given air charge as directed by (LAMBSE). The DELTAKAMRF term may be computed by subtracting the value of the keep-alive-memory term stored from the previous start (KAMRFk−1) from the value of the keep-alive-memory term during the current start-up (KAMRFk). KAMRF is a closed-loop adaptive air-fuel correction factor stored in keep-alive memory (KAM) of the controller. However, in some example, RAM or other suitable memory can be used to store the keep alive memory terms.

KAMRF can utilize closed-loop adaptive learning in order to compensate for air/fuel ratio offset errors that may be caused by certain events or actions. The DELTAKAMRF term is included in at least some examples in order to improve the accuracy of the STARTUP_LAMBSE value by accounting for any changes in closed-loop, air/fuel ratio offset errors that are learned in KAMRF between starts. Note that in this example, the DELTAKAMRF is implemented as an adder term. In other embodiments, the KAMRF compensation may be in the form of a ratio-metric multiplier (e.g. (KAMRFk)/(KAMRFk−1)) that may be applied to either the LAMBSE term or ACES_OFFSET term, or as the sum of these two terms. The routine can then proceed to 532.

At 532, conditions may be checked by the controller to determine whether or not the HFD algorithm has been invoked to provide engine speed correction when the engine speed varies from the expected or prescribed engine speed during start-up. If the HFD algorithm was not invoked, the routine can proceed to 544. Otherwise, the routine can proceed to 534 the HFD algorithm is executed by the controller. At 536, the maximum value of the anti-stall multiplier terms from the HFD algorithm can be captured and assigned to the parameter ANTISTALLMUL_MAX. The anti-stall multiplier terms may be used in calculations that compute the additional amount of open-loop fuel required to correct the engine speed errors during engine run-up. These errors are expressed as the differences between the actual (measured) engine speed and a prescribed engine speed profile during the engine run-up process. Note that in this example, the maximum value of the anti-stall multiplier term is used. However, in other examples of the HFD algorithm, a mean or average value of the anti-stall multiplier terms may be computed and used instead by the ACES algorithm. As yet another example, a weighted or skewed average of the anti-stall multiplier terms may be computed and used.

At 538, the ACES proportional (ACES_P), ACES integral (ACES_I), and the ACES derivative (ACES_D) terms may be computed from the ACES PID controller. The proportional term (ACES_P) can be computed by multiplying the current maximum value of the anti-stall multiplier term (ANTISTALLMUL_MAX) from 536 by a proportional gain term (GAIN_P). The integral term (ACES_I) can be computed by summing the product of the current ANTISTALLMUL_MAX value and an integral gain term (GAIN_I) with the ACES integral value (ACES_I_LAST) computed from the previous engine start-up under similar start-up conditions (engine coolant temperature, ambient temperature, and/or barometric pressure) and stored in memory at the controller.

The derivative term (ACES_D) can include the product of a differential gain term (GAIN_D) and the difference between the current ANTISTALLMUL_MAX value and the value of the Anti-Stall Multiplier term (ANTISTALL_MAX_LAST) stored in memory at the controller from the previous engine start-up under similar start-up conditions. During cold engine start-up, a portion of the injected fuel may not be available to the cylinder for combustion. The amount of the injected fuel that is actually provided to the cylinder may be influenced by intake port surface temperature at start-up and fuel volatility (vapor pressure and distillation properties) for port injected engines. Therefore, the values for the proportional, integral and differential gain terms may be at least partially dependent upon either engine coolant or cylinder head temperature (ECT or CHT), as well as, upon other operating conditions. These operating conditions may include a partial dependence on barometric pressure (e.g. to account for altitude effects). Also, the dependencies on these operating conditions may be either linear or non-linear, and these gain terms may have either positive or negative values. The gain terms can be stored in memory at the controller, and memory storage may be in the form of a single value, a two dimensional transfer function (f of x) value, or a multi-dimensional look-up table values, among others.

From 538, the routine can proceed to 540, where the ACES offset term (ACES_OFFSET) can be computed by adding the proportional, integral and derivative controller terms: ACES_P, ACES_I, and ACES_D. At 542, the ACES_OFFSET value, computed at 540, can be assigned to the ACES_I_LAST parameter. The value of ANTISTALLMUL_MAX, determined at 536, can be assigned to the parameter, ANTISTALLMUL_MAX_LAST. The terms ACES_OFFSET, ACES_I_LAST and ANTISTALLMUL_MAX can then be stored as signed (+/−) values in memory at the controller. Memory storage may be in the form of a single value, a two dimensional transfer function (f of x) value, or a multi-dimensional look-up table values, among others. Additionally, these terms may be at least partially dependent upon either engine coolant or cylinder head temperature (ECT or CHT), as well as, upon other operating conditions, including barometric pressure.

The routine can then proceed to 544 where the current value of KAMRF can be stored for use during the next cold start as KAMRFk−1. If the process proceeds to 516 from 514, a check may be made by the controller to determine if the fuel tank has been either partially or completely re-filled. As one example, the controller may utilize one or both of sensors 75 and 77 to determine whether a refueling event has occurred and the extent of the refueling event (e.g. how much fuel has been added). If a fuel tank re-fill event has not occurred, the routine can proceed to 526. Alternatively, if a re-fill event has occurred, the routine can proceed to 518 where the current fuel fill level (e.g. which indicative of the amount of fuel stored on-board the vehicle) can be recorded by the controller and can be compared with the fuel level before the re-fill event. At 520, in the absence of a sensor that identifies fuel type, speciation or volatility characteristics, the ACES_OFFSET and ACES_I_LAST terms stored in memory at the controller can be adjusted by multiplying them by a fuel ratio of (OLD_FUEL_AMOUNT)/(NEW_FUEL_AMOUNT+OLD_FUEL_AMOUNT), where the OLD_FUEL AMOUNT term is the volumetric amount (or mass) of fuel before the re-fill event and NEW_FUEL_AMOUNT is the volumetric amount (or mass) of new fuel introduced into the fuel tank after the re-fill event.

Since the ACES_OFFSET and ACES_I_LAST terms were learned, in some examples, based on the engine response to the pre-refill or “old” fuel, this adjustment can be made in order to account for the presence of a known amount of the unknown fuel that was introduced into the fuel tank, and may be used by the engine on subsequent cold-starts. In this particular example, the ACES_OFFSET and ACES_I_LAST terms are multiplied by the fuel ratio or (OLD_FUEL_AMOUNT)/(NEW_FUEL_AMOUNT+OLD_FUEL_AMOUNT). In another example, the ACES_OFFSET and ACES_I_LAST terms may be reset or initialized to either zero or some pre-determined non-zero values responsive to the fuel re-fill event.

At 522, the adjusted values of the ACES_OFFSET (ADJUSTED_ACES_OFFSET) and the ACES_I_LAST (ADJUSTED_ACES_I_LAST) based on the fuel ratio at 520 can be stored in memory at the controller. At 524, the controller can perform a calculation of the volumetric amount (or mass) of the pre-refill or “old” fuel remaining in the fuel lines, intake manifold and/or fuel injectors that needs to be removed from the fuel and air intake systems before the new fuel or a mixture of the old fuel and the new fuel can reach the engine. This value may be referred to as FUEL_OLD. The time or number of injection events for the amount of fuel FUEL_OLD to be cleared from the fuel and air intake system before the new fuel can be delivered to the engine can be estimated based upon the amount of fuel delivered to engine while running or during start-up as directed by STARTUP_LAMBSE, which in turn is a function of LAMBSE, ACES_OFFSET (or ADJUSTED_ACES_OFFSET), and DELTA_KAMRF. Thus, use of the ADJUSTED_ACES_OFFSET and ADJUSTED_ACES_I_LAST terms during a subsequent start-up can be delayed until the estimated amount of the old fuel remaining in the fuel system has be used by the engine.

For example, at 526, the controller can check to determine if the volume (or mass) of the old fuel remaining in the fuel lines, manifold and injectors has been depleted. If the volume (or mass) of the old fuel has not yet been depleted, the routine can by-pass 528, whereby the routine can return. Otherwise, the routine can proceed to 528, where the ACES_OFFSET term is assigned the value of the ADJUSTED_ACES_OFFSET from 522 and the ACES_I_LAST term is assigned the value of the ADJUSTED_ACES_I_LAST from 522. The ACES_OFFSET and ACES_I_LAST terms can then be stored as signed (+/−) values in memory at the controller.

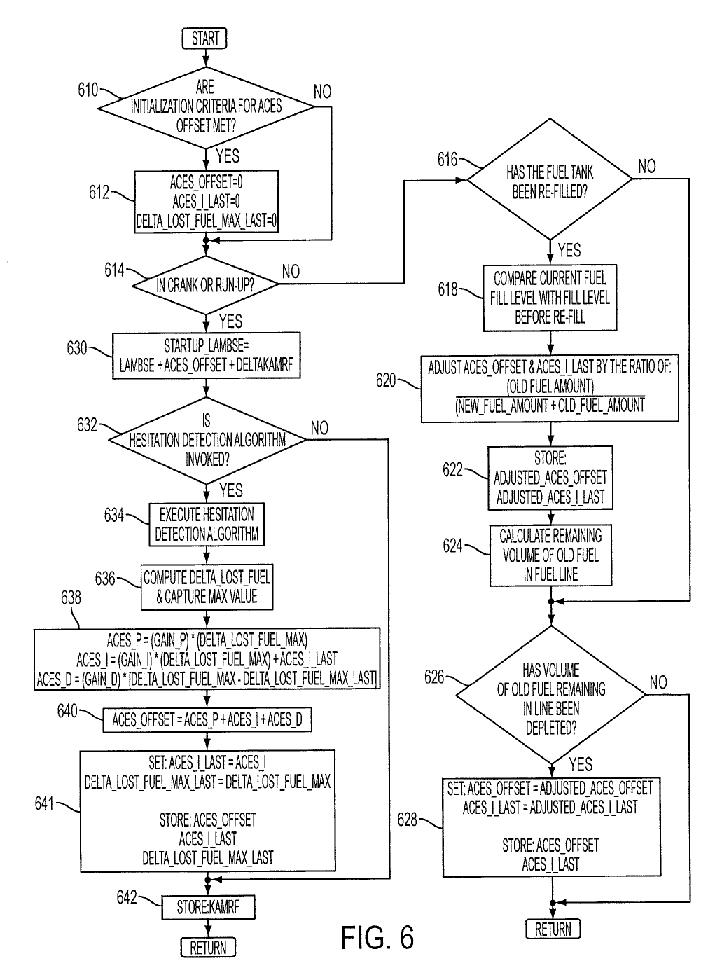

FIG. 6 provides another example of a flow chart depicting the routine of FIG. 4 in greater detail. In this particular example, the anti-stall multiplier terms (ANTISTALLMUL) and (ANTISTALLMUL_MAX) are not used by the controller. However, the process flow in FIG. 6 is similar to FIG. 5 in many respects. For example, at 610, it may be judged whether initialization criteria for ACES have been met as similarly described with reference to 510.

If the answer at 610 is, the ACES offset term (ACES_OFFSET) and the ACES integral term (ACES_I_LAST) are initialized at 612, in a manner similar to that of 512. The term, DELTA_LOST_FUEL_MAX_LAST, stored in memory at the controller is also initialized (e.g. set to zero or some other specified value). Thus, although these terms have been initialized to zero in this example, these same terms may be initialized to non-zero values in other applications of this algorithm. The routine then proceeds through 614, 630, 632, and/or 634 as similarly described with reference to the operations of 514, 530, 532, and 534 of FIG. 5.

At 636, a “lost fuel” difference term (DELTA_LOST_FUEL) may be computed and the maximum value is captured. The term “lost fuel” is a cold-start, open-loop phenomenon, in which a large portion of the injected fuel is not available in the cylinder for combustion. For example, with port injected engines, a portion of the injected fuel may be retained in the intake manifold via wall wetting as the intake manifold may act as a fuel buffer during engine starting. This can significantly impact open-loop fueling precision during the crank and run-up stages of the engine start-up process, for example, by reducing and/or delaying the provision of fuel to the combustion chamber. The cold-start “lost fuel” effect can be attributed to reduced fuel vaporization and may be heavily influenced by intake port surface temperature at start-up and/or fuel volatility or quality (e.g. vapor pressure and distillation properties). Although physics based models have been developed to predict the quantity of “lost fuel” as a function of time as the engine warms up to normal operating temperature, these models typically require additional inputs that are difficult or costly to accurately measure or infer, thus affecting the reliability of the time-based “lost fuel” prediction.

In some engine control applications, the base open-loop fuel lambda term (LAMBSE) calculation may attempt to compensate for the “lost fuel” effect using calibratible, time and temperature based lambda (air/fuel ratio) offset tables. For those cold starts in which the HFD algorithm is invoked, a unique “lost fuel” table may be used for the base open-loop fuel lambda (LAMBSE) calculation. This “lost fuel” table may include lambda offset values that are typically more enriched when compared to the lambda offset values in the base “lost fuel” table used when the HFD algorithm is not invoked.

It is proposed herein that a “lost fuel” difference term (DELTA_LOST_FUEL) be calculated based on the difference between the lambda offset value from the “lost fuel” table when HFD algorithm is invoked (HES_LOST_FUEL) and the lambda offset value from the base “lost” fuel table when HFD algorithm is not invoked (NON_HES_LOST_FUEL), as described by the following equation: DELTA_LOST_FUEL (HES_LOST_FUEL)−(NON_HES_LOST_FUEL). The maximum value of DELTA_LOST_FUEL may be captured and assigned to the parameter DELTA_LOST_FUEL_MAX as a negative number, in this particular example. Note that while the maximum value of the DELTA_LOST_FUEL terms is captured in the example routine of FIG. 6, in other examples of this algorithm, a mean or average value of the DELTA_LOST_FUEL terms may be computed and used instead. In still another example, a weighted or skewed average of the DELTA_LOST_FUEL terms may be computed and used.

At 638, the ACES proportional (ACES_P), integral (ACES_I) and derivative (ACES_D) controller terms may be computed. The proportional term (ACES_P) can be computed by multiplying the current maximum value of the DELTA_LOST_FUEL term, DELTA_LOST_FUEL_MAX, from 636 by a proportional gain term (GAIN_P). The integral term (ACES_I) can be computed by summing the product of the current DELTA_LOST_FUEL_MAX value and an integral gain term (GAIN_I) with the ACES integral value (ACES_I_LAST) computed from the previous start-up under similar start-up conditions (engine coolant temperature, ambient temperature, and/or barometric pressure) and stored in memory at the controller.

The derivative term (ACES_D) includes the product of a differential gain term (GAIN_D) and the difference between the current DELTA_LOST_FUEL_MAX value and the value of the DELTA_LOST_FUEL term (DELTA_LOST_FUEL_MAX_LAST) stored in controller memory from the previous start-up under similar start-up conditions. Note that DELTA_LOST_FUEL_MAX_LAST can include the maximum DELTA_LOST_FUEL term obtained from the previous engine start.

As described previously described with reference to FIG. 5, the values for the proportional, integral and differential gain terms may be at least partially dependent upon either engine coolant or cylinder head temperature (ECT or CHT) and/or ambient air temperature, as well as, upon other operating conditions. These operating conditions may include at least a partial dependence on barometric pressure (e.g. to account for altitude effects). Also, the dependencies may be either linear or non-linear, and these gain terms may have either positive or negative values. These gain terms may be stored in memory at the controller, and memory storage may be in the form of a single value, a two dimensional transfer function (f of x) value, or multi-dimensional look-up table values. Additionally, when the HFD algorithm is invoked during engine run-up, the amount of “lost fuel” correction may be dependent upon the magnitude of the difference between the actual (measured) engine speed (N) and the target (expected) engine speed (N_EXP) from the run-up speed profile stored in memory at the controller. Therefore, the proportional, integral and differential gain terms may also exhibit a partial dependence on the magnitude of this speed difference as represented by (N−N_EXP).

After calculating the ACES offset term (ACES_OFFSET) at 640, the routine can proceed to 641. At 641, the ACES_OFFSET value, computed at 640, can be assigned to the ACES_I_LAST parameter. The value of DELTA_LOST_FUEL_MAX, determined at 636, can be assigned to DELTA_LOST_FUEL_MAX_LAST. The terms ACES_OFFSET, ACES_I_LAST and DELTA_LOST_FUEL_MAX can then be stored in memory as signed values. Memory storage may be in the form of a single value, a two dimensional transfer function (f of x) value, or multi-dimensional look-up table values. Additionally, these terms may be at least partially dependent upon either engine coolant or cylinder head temperature (ECT or CHT), as well as, upon other conditions, including barometric pressure or the magnitude of the speed difference between the measured and target engine speeds during run-up.

As in the routine of FIG. 5, the routine can then proceed to 642, whereby KAMRF may be stored before the routine returns. It should be appreciated that operations 616-628 of FIG. 6 correspond to operations 516-528 of FIG. 5 as previously described.

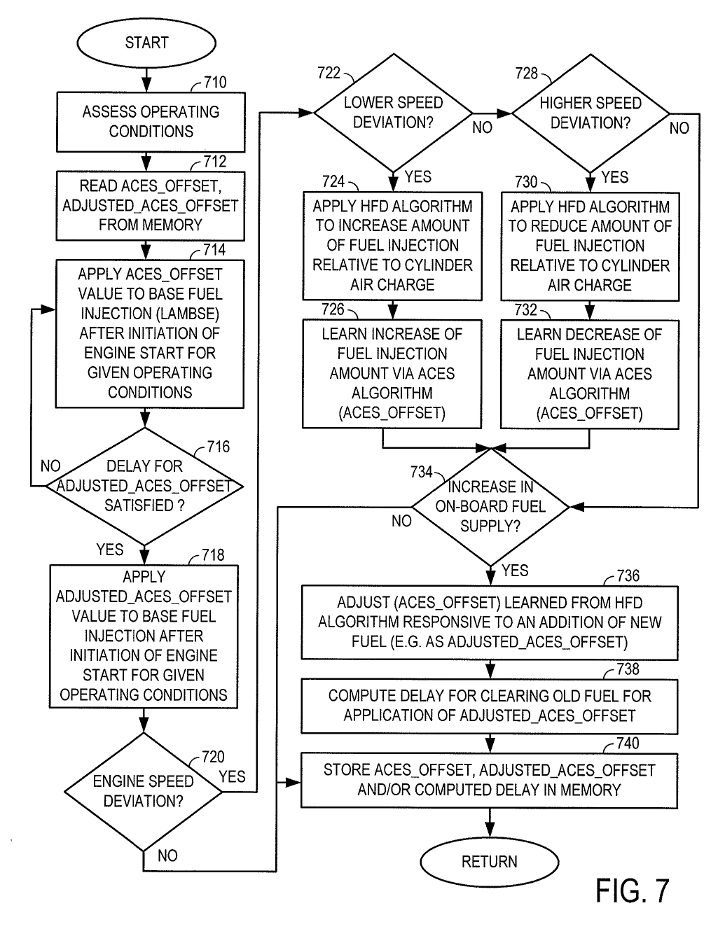

FIG. 7 shows a flow chart depicting an example control strategy that may be used to apply the ACES and/or HFD algorithms described herein. At 710, the controller can assess the operating conditions of the engine via the various sensors described with reference to FIG. 1. For example, the controller can identify engine temperature (e.g. via engine coolant and/or cylinder head temperature), ambient conditions including air temperature, air pressure, etc., and other conditions.

At 712, the ACES_OFFSET and/or the ADJUSTED_ACES_OFFSET terms can be read from memory by the controller. At 714, the controller can apply the ACES_OFFSET value to the base fuel injection amount indicated by LAMBSE for the given operating conditions identified at 710 after initiation of engine start-up. For example, the controller can correct the base fuel injection for the given operating conditions by adding the ACES_OFFSET term and/or the DELTA_KAMRF term to determine a corrected fuel injection amount indicated by the STARTUP_LAMBSE term.

At 716, the controller may judge whether the delay for application of the ADJUSTED_ACES_OFFSET (if any) has been satisfied. For example, where a refueling operation has occurred between the current engine start-up and a previous engine start-up, then the ACES_OFFSET may have been adjusted responsive to the magnitude of the refueling operation as indicated by ADJUSTED_ACES_OFFSET. As described with reference to FIGS. 5 and 6, the controller can identify the volume or mass of the old fuel retained in the fuel system and/or air intake system in order to identify a duration of time or delay (e.g. number of injection events, strokes, cycles, etc.) after initiation of the engine start for the new fuel to be provided to the engine. If the duration of time or delay identified by the controller has been exceeded, the routine can proceed to 718. Alternatively, if the delay has not been exceeded, then the routine can return to 714, where the ACES_OFFSET obtained from a previous engine start may be used.

At 718, the controller can instead apply the ADJUSTED_ACES_OFFSET term to determine the STARTUP_LAMBSE term rather than the ACES_OFFSET term, since the new fuel by which the ADJUSTED_ACES_OFFSET term has been selected can reach the engine as a mixture of both the new and old fuels. For example, the engine controller can increase or decrease the fuel injection amount from the amount directed by ACES_OFFSET to the amount directed by ADJUSTED_ACES_OFFSET. Note that the controller can increase or decrease fuel injection in any of the examples described herein by increasing the pulse width of the injector, increasing the fuel injection pressure, and/or increasing the number of injections per cycle.

At 720, it may be judged whether the measure engine speed has deviated sufficiently from an expected engine speed profile stored in memory to invoke the HFD algorithm. If the answer at 720 is yes, the routine can proceed to 722. Alternatively, if the answer at 720 is no, the routine can instead proceed to 740. At 722, it may be judged whether the engine speed deviation included a measured engine speed that was less than the expected engine speed profile. If the answer is yes, the routine can proceed to 724. At 724, the HFD algorithm can be applied by the controller to increase the amount of the fuel injection relative to the cylinder air charge. In other words, the control system can adjust the amount of fuel injected into the engine to reduce the air/fuel ratio, thereby increasing engine speed. Note that the increase in fuel injection amount can be proportionate to the engine speed deviation. For example, a greater deviation in engine speed can result in a greater increasing in fuel injection amount. At 726, the controller can implement the ACES algorithm to learn the increase in fuel injection amount by updating the ACES_OFFSET for subsequent engine starts.

Alternatively, if the answer at 722 is no, the routine can proceed to 728, where it may be judged whether the engine speed deviation included a measured engine speed that was greater than the expected engine speed profile. If the answer is yes, the routine can proceed to 730. At 730, the HFD algorithm can be applied by the controller to reduce the amount of the fuel injection relative to the cylinder air charge. In other words, the control system can adjust the amount of fuel injected into the engine to increase the air/fuel ratio, thereby reducing engine speed. Note that the reduction in fuel injection amount can be proportionate to the engine speed deviation. For example, a greater deviation in engine speed can result in a greater decrease in fuel injection amount. At 732, the controller can implement the ACES algorithm to learn the increase in fuel injection amount by updating the ACES_OFFSET for subsequent engine starts.

If the answer at 728 is no, or from 732 or 726, it may be judged at 734 whether an increase in the on-board fuel supply has occurred. If the answer at 734 is yes, the routine can proceed to 736. At 736, the ACES_OFFSET term updated at 732 or 726 can be adjusted as indicated by ADJUSTED_ACES_OFFSET based on the addition of new fuel to the fuel storage tank. As described with reference to FIGS. 5 and 6, this adjustment may be based on the increase in new fuel relative to the amount of old fuel. The ADJUSTED_ACES_OFFSET can be used by the engine controller for identifying a fuel injection amount during a subsequent engine start, for example, after the delay for clearing the old fuel from the fuel and air intake systems has occurred. Thus, at 738, the controller can compute the delay or duration of time necessary for the new fuel to reach the engine, whereby the computed delay may be stored in memory and utilized during a subsequent engine start. Note that the delay may include a number of injection events, a number of strokes, a number of cycles, etc. and can be identified by the controller via a look-up table, function, or map stored in memory.

If the answer to 734 or 720 is no, the routine proceeds to 740 where the controller can store the values acquired during the current engine start for subsequent engine starts, including ACES_OFFSET, ADJUSTED_ACES_OFFSET (if any), and the computed delay for initiation of ADJUSTED_ACES_OFFSET, among the other terms and parameters described herein. From 738 the routine proceeds to 740. Finally, the routine may return for the subsequent engine cycle or engine starting event.

It will be appreciated that the configurations and routines disclosed herein are exemplary in nature, and that these specific embodiments are not to be considered in a limiting sense, because numerous variations are possible. For example, the above approaches can be applied to V-6, I-4, I-6, V-12, opposed 4, and other engine types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for controlling a relative amount of air and fuel provided to a combustion chamber of an internal combustion engine, the method comprising:
adjusting an amount of air or fuel provided to the combustion chamber during an engine start based on a volatility of the fuel identified during a previous engine start and based on a change of an amount of the fuel stored on-board the vehicle before the engine start.

2. (canceled)

3. The method of claim 1, wherein the amount of fuel provided to the combustion chamber is reduced relative to the amount of air provided to the combustion chamber during the engine start in response to an increase in an amount of fuel stored on-board the vehicle between the engine start and the previous engine start.

4. The method of claim 1, wherein the amount of air provided to the combustion chamber is decreased relative to the amount of fuel provided to the combustion chamber by increasing the amount of fuel provided to the combustion chamber.

5. The method of claim 1, wherein the volatility of the fuel is identified based on an engine speed run-up from rest during the previous engine start.

6. The method of claim 5, wherein the engine speed response includes a maximum engine speed error from an expected engine speed attained by the engine during the previous engine start as an indication of the volatility of the fuel.

7. The method of claim 5, wherein the engine speed response includes an average engine speed during the previous engine start as an indication of the volatility of the fuel.

8. The method of claim 5, wherein the volatility of the fuel is further identified based on an engine speed response for each of a plurality of previous engine starts, and an indication of an amount of fuel stored in a fuel tank.

9. A vehicle engine system, comprising:
an internal combustion engine including at least one combustion chamber;
a fuel injector configured to provide fuel to the combustion chamber;
a fuel system operatively coupled with the fuel injector including a fuel storage tank;
a control system configured to vary an amount of fuel injected into the combustion chamber during an engine start based on a speed response of the engine during a previous engine run-up from rest and a change in an amount of fuel stored in the fuel storage tank before the engine start.

10. The system of claim 9, further comprising a fuel sensor operatively coupled with the control system and configured to indicate an amount of fuel stored in the fuel storage tank, wherein the change in the amount of fuel stored in the fuel storage tank is identified by the control system via a change in an output provided to the control system by the fuel sensor.

11. The system of claim 9, wherein the control system is configured to increase the amount of fuel injected into the combustion chamber during the engine start relative to an amount of fuel previously injected into the combustion chamber during the previous engine start responsive to an engine speed response during the previous engine start that includes a reduction in engine speed.

12. The system of claim 9, wherein the control system is configured to reduce said increase of the amount of fuel injected into the combustion chamber during the engine start responsive to an increase in the amount of fuel stored in the fuel storage tank between the engine start and the previous engine start.

13. The system of claim 9, wherein the control system is configured to reduce the amount of fuel injected into the combustion chamber during the engine start relative to an amount of fuel previously injected into the combustion chamber during the previous engine start responsive to an increase in the amount of fuel stored in the fuel storage tank between the engine start and the previous engine start.

14. The system of claim 9, wherein the control system is configured to reduce the amount of fuel injected into the combustion chamber during the engine start relative to an amount of fuel previously injected into the combustion chamber during the previous engine start responsive to an engine speed response during the previous engine start that surpasses a speed threshold.

15. The system of claim 9, wherein the control system is configured to further reduce the amount of fuel injected into the combustion chamber during the engine start relative to an amount of fuel previously injected into the combustion chamber during the previous engine start responsive to an increase in an amount of fuel stored in the fuel storage tank between the engine start and the previous engine start.

16. A method of operating an internal combustion engine, the method comprising:
performing a first engine start by providing a first fuel injection profile to the engine;
performing a second engine start after the first engine start by providing a second fuel injection profile to the engine; and
during the second engine start, adjusting the second fuel injection profile relative to the first fuel injection profile based on a fuel volatility and based on a chance in an amount of fuel stored on-board the vehicle before the second engine start, wherein the fuel volatility is based on an engine speed response during at least an engine speed run-up of the first engine start.

17. The method of claim 16, wherein the second fuel injection profile is adjusted by varying an amount of fuel delivered to the engine during the second engine start.

18. The method of claim 16, wherein the second fuel injection profile is reduced relative to the first when there is a lower engine speed during the first engine start; and wherein the second fuel injection profile is increased or held constant relative to the first when there is a higher engine speed during the first engine start for a given operating condition.

19. (canceled)

20. The method of claim 16, wherein the fuel stored on-board the vehicle is stored in a fuel storage tank including a fuel sensor configured to provide an indication of an amount of fuel stored in the fuel storage tank, and wherein the change in the amount of fuel stored on-board the vehicle is identified by a change in the indication provided by the fuel sensor.
